(19) United States
(12) Patent Application Publication
(10) Pub. No.: US 2009/0098262 A1
(43) Pub. Date: Apr. 16, 2009

(54) Optionally Modified/Insoluble Vegetable Gums for Removing Natural or Synthetic Organic Impurities from Liquid Media Contaminated Therewith

(75) Inventors: Caroline Mabille, Paris (FR); Jean-Francois Sassi, Ploubazlanec (FR); Vincent Monin, Plainsboro, NJ (US); Yves Mottot, Puteaux (FR)

Correspondence Address: BUCHANAN, INGERSOLL & ROONEY PC, POST OFFICE BOX 1404, ALEXANDRIA, VA, 22313-1404, US

(73) Assignee: Rhodia UK Limited, Hertfordshire (GB)

(21) Appl. No.: 11/630,723

(22) PCT Filed: Jun. 28, 2005
(86) PCT No.: PCT/FR2005/001638

§ 371 Date: Aug. 15, 2008

(30) Foreign Application Priority Data
Jun. 29, 2004 (FR) 0407143

(51) Int. Cl. B01J 20/24; B01D 15/00; C02F 1/28; B01J 41/12; B01J 20/26; C02F 1/42

(52) U.S. Cl. 426/422; 210/690; 210/679; 210/691

(57) ABSTRACT

Unwanted natural and synthetic organic impurities are removed from liquid media contaminated therewith, e.g., liquids and beverages intended for human consumption, or industrial/wastewaters, by introducing into such media a thus effective amount of an optionally modified/insoluble cationic vegetable gum containing one or more cationic or cationizable substituents, maintaining the cationic vegetable gum in such liquid medium until the organic impurities are sorbed thereon, and thence recovering the vegetable gum/sorbed impurities therefrom, whereby purifying the liquid medium.

The invention relates to the use of an optionally modified and optionally insoluble vegetable gum for eliminating natural or synthetic organic substances in liquids and in particular liquids intended for consumption such as drinking water, beverages, fruit juices or syrups, and also natural waters, industrial waters or wastewater.

The natural organic matter in water may cause many problems. It is responsible for the degradation of the organoleptic properties of drinking water, i.e. the taste, the color or the odor of the water. It may cause bacterial reviviscence or generate potentially toxic by-products of disinfection.

The synthetic organic matter present in water results mainly from agricultural or industrial pollution. This synthetic organic matter may be toxic and may be responsible for health problems.

Elimination of the natural and synthetic organic matter present in water is thus an essential objective for ensuring the quality of the drinking water produced from natural waters. In France, Decree No. 2001-1220 of 20 Dec. 2001 sets the quality references and limits to be respected for the production of water intended for human consumption. By way of example, the quality limit for synthetic organic matter such as benzene is 1 microgram per liter, and the quality reference for the total organic carbon (TOC) of a water intended for human consumption, is set to a value of 2.0 mg/l.

Moreover, natural or synthetic organic substances present in beverages or in liquid compositions for consumption such as syrups can modify their properties, in particular their appearance (cloudiness or coloration). This is why it is also important to find a means for removing these natural or synthetic organic substances that is compatible with the food regulations.

Moreover, it may be necessary to treat industrial waters and in particular waters originating from the agrifood industry or wastewater rich in natural or synthetic organic matter before discharging them into nature to avoid pollution.

Finally, it may also be necessary to treat natural waters rich in organic substances to convert them into waters for industrial use. Mention may be made especially of the production of water for the agrifood, pharmaceutical or electronic industry.

It was known practice hitherto to use active charcoal, ion-exchange resins or cationic celluloses to eliminate the natural or synthetic organic substances present in water.

However, the use of active charcoal requires a large amount of active charcoal and is of high cost.

Exchange resins are relatively inefficient. Specifically, it is known in the field of ion exchange that natural or synthetic organic substances are poisons for resins. The use of exchange resins also makes it necessary to manage an additional effluent associated with the regeneration, which is made necessary on account of the high cost of these products.

The use of cationic celluloses in fibrous form is described in U.S. Pat. No. 5,152,896. The crystalline nature of cellulose in fibrous form is such that only the accessible and modified surface is available for trapping, which limits the maximum adsorption capacity and slows down the exchange kinetics.

Moreover, all the products mentioned previously have the drawback of not efficiently eliminating trihalomethane precursors, which are carcinogenic, and which are present in drinking water.

There is still a need to find a means for eliminating the natural or synthetic organic substances present in liquids that does not have the drawbacks indicated above, i.e. which is simple to implement, inexpensive and compatible with food applications.

One of the aims of the present invention is also to be able to efficiently treat a drinking water and in particular to eliminate the trihalomethane precursors.

These aims and others are achieved by the present invention, one subject of which is thus the use of an optionally modified and optionally insoluble vegetable gum for the elimination of natural or synthetic organic substances in liquids and in particular liquids intended for consumption such as drinking water, beverages such as beer or nonalcoholic beverages, fruit juices or syrups, and also natural waters, industrial waters or wastewater.

No particular limitation is set on the vegetable gum used in the invention, and examples of vegetable gums that may be used include glucomannans, for instance konjac, xyloglucans, for instance tamarind gum, galactomannans, for instance guar, carob, tara, fenugreek or mesquite gum, or gum arabic, or mixtures thereof.

Preferably, galactomannans are preferred, and in particular guars.

No particular limitation is set on the purity of the vegetable gum. In this sense, natural meals rich in vegetable gum may also be used, for instance native guar powder or native carob powder without any refining, or mixtures thereof.

The term “vegetable gum” used hereinbelow denotes both purified vegetable gums and natural meals.

The vegetable gum is optionally modified to improve its affinity for the natural or synthetic organic substances, and thus to improve its capacity to take up the natural or synthetic organic matter, on the one hand, and to make it insoluble, on the other hand, which allows it to be separated more easily from the liquid solution to be treated.

These modifications intended to improve the affinity of the vegetable gum for the natural or synthetic organic substances, and to make it insoluble, may be performed separately and in the order desired. It may also be possible to perform these modifications simultaneously.

Among the modifications of the vegetable gum intended to improve its affinity for the natural or synthetic organic substances, mention may be made of the introduction of cationic or cationizable groups. The term “cationizable groups” means groups that may be made cationic as a function of the pH of the medium.

Among the cationic or cationizable groups that may be mentioned are groups comprising quaternary ammoniums or tertiary amines, pyridiniums, guanidiniums, phosphoniums or sulfoniums.

The cationic modified vegetable gums used in the invention may be obtained by conventionally reacting the vegetable gum starting materials mentioned above.

The introduction of cationic or cationizable groups into the vegetable gum may be performed by means of a nucleophilic substitution reaction.

When it is desired to introduce an ammonium group, the suitable reagent used may be:
3-chloro-2-hydroxypropyltrimethylammonium chloride, sold under the name Quab 188 by the company Degussa;
an epoxide bearing a quaternary ammonium such as 2,3-epoxypropyltrimethylammonium chloride sold under the name Quab 151 by the company Degussa or similar compounds;
diethylaminoethyl chloride;
   or Michael acceptors, for instance acrylates or methacrylates bearing quaternary ammoniums or tertiary amines.

The introduction of cationic or cationizable groups into the vegetable gum may be performed by esterification with amino acids, for instance glycine, lysine, arginine or 6-aminocaproic acid, or with quaternized amino acid derivatives, for instance betaine hydrochloride.

The introduction of cationic or cationizable groups into the vegetable gum may also be performed via radical polymerization comprising the grafting of monomers comprising at least one cationic or cationizable group onto the vegetable gum.

The free radical initiation may be performed using cerium, as described in the publication in the European Polymer Journal, Vol. 12, pp. 535-541, 1976. The free-radical initiation may also be performed with ionizing radiation and in particular bombardment with a beam of electrons.

The monomers comprising at least one cationic or cationizable group used to perform this free-radical polymerization may be, for example, monomers comprising at least one ethylenic unsaturation and at least one quaternary or quaternizable nitrogen atom by adjusting the pH.

Among these monomers comprising at least one ethylenic unsaturation and at least one quaternary or quaternizable nitrogen atom by adjusting the pH, mention may be made of the compounds of formulae (I), (II), (III), (IV) and (V) below:

the compound of general formula (I)

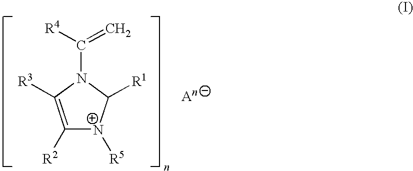

in which:
A^{nΘ} represents a Cl^{Θ}, Br^{Θ}, I^{Θ}, SO₄^{2Θ}, CO₃^{2Θ}, CH₃—OSO₃^{Θ}, OH^{Θ} or CH₃—CH^{Θ}₂—OSO₃^{Θ} ion,
R¹ to R⁵, which may be identical or different, represent, independently of each other, an alkyl group containing from 1 to 20 carbon atoms, a benzyl radical or an H atom, and
n is 1 or 2, or
   the compound of general formula (II)

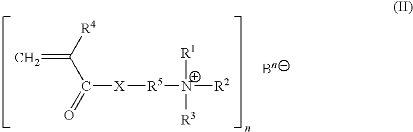

in which:
X represents an —NH group or an oxygen atom O,
R⁴ represents a hydrogen atom or an alkyl group containing from 1 to 20 carbon atoms,
R⁵ represents an alkylene group containing from 1 to 20 carbon atoms,
R¹, R² and R³, which may be identical or different, represent, independently of each other, an alkyl group containing from 1 to 20 carbon atoms,
B^{NΘ} represents a Cl^{Θ}, Br^{Θ}, I^{Θ}, SO₄^{2Θ}, CO₃^{2Θ}, CH₃—OSO₃^{Θ}, OH^{Θ} or CH₃—CH₂—OSO₃^{Θ} ion, and
n is 1 or 2, or
   the compound of general formula (III)

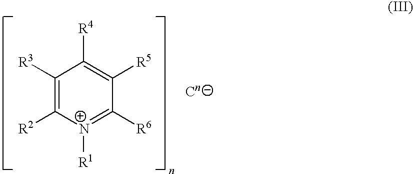

in which:
R¹ to R⁶, which may be identical or different, represent, independently of each other, a hydrogen atom or an alkyl group containing from 1 to 20 carbon atoms, but with one of the groups R¹ to R⁶ representing a
—CH═CH₂ group,
C^{NΘ} represents a Cl^{Θ}, Br^{Θ}, I^{Θ}, SO₄^{2Θ}, CO₃^{2Θ}, CH₃—OSO₃^{Θ}, OH^{Θ} or CH₃—CH₂—OSO₃^{Θ} ion, and
n is 1 or 2, and
   the compound of general formula (IV)

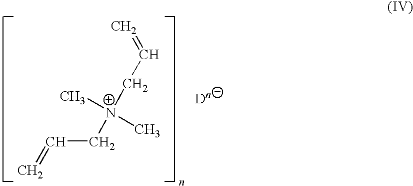

in which:
D^{nΘ} represents a Cl^{Θ}, Br^{Θ}, I^{Θ}, SO₄^{2Θ}, CO₃^{2Θ}, CH₃—OSO₃^{Θ}, OH^{Θ} or CH₃—CH₂—OSO₃^{Θ} ion, and
n is 1 or 2.

Preferably, the monomers comprising at least one ethylenic unsaturation and at least one quaternary or quaternizable nitrogen atom are chosen from:
2-dimethylaminoethyl acrylate (DAEA),
quaternized 2-dimethylaminoethyl acrylate (DAEA-Quat),
2-dimethylaminoethyl methacrylate (DMAEMA),
quaternized 2-dimethylaminoethyl methacrylate (DMAEMA-Quat),
2-diethylaminoethyl methacrylate quaternized in chloride form, known as Pleximon 735 or TMAE MC 80 by the company Röhm,
diallyldimethylammonium chloride (DADMAC),
trimethylammoniumpropylmethacrylamide in chloride form, known as MAPTAC, or
mixtures thereof.

The cationic modified vegetable gum may contain cationic or cationizable units derived from a chemical transformation after polymerization of monomers that are precursors of cationic or cationizable functions. Examples that may be mentioned include poly(p-chloro-methylstyrene), which, after reaction with a tertiary amine such as a trimethylamine, forms quaternized poly(para-trimethylaminomethylstyrene).

The cationic or cationizable units are combined with negatively charged counterions. These counterions may be chosen from chloride, bromide, iodide, fluoride, sulfate, methyl sulfate, phosphate, hydrogen phosphate, phosphonate, carbonate, hydrogen carbonate and hydroxide ions.

Counterions chosen from hydrogen phosphates, methyl sulfates, hydroxides and chlorides are preferably used.

The degree of substitution of the cationic modified vegetable gums used in the invention is at least 0.01 and preferably at least 0.1.

If the degree of substitution is less than 0.01, the efficacy of the elimination of the natural or synthetic organic matter from the liquid to be treated is reduced.

If the degree of substitution exceeds 0.1, the vegetable gum inevitably swells in the liquid. In order to be able to use a modified vegetable gum substituted to a degree of greater than 0.1, it is preferable to subject it to a modification to make it insoluble. These modifications are described later.

The degree of substitution of the cationic modified vegetable gum corresponds to the mean number of cationic charges per sugar unit.

Among the modifications of the vegetable gum intended to improve its affinity for the natural or synthetic organic substances, mention may also be made of the introduction of groups bearing an anionic or anionizable charge.

The anionic modified vegetable gum that is used in the invention may be obtained by conventionally reacting the vegetable gums mentioned above with an anionizing agent such as propane sultone, butane sultone, monochloroacetic acid, chlorosulfonic acid, maleic anhydride, succinic anhydride, citric acid, sulfates, sulfonates, phosphates, phosphonates, orthophosphates, polyphosphates or metaphosphates, and the like.

The degree of substitution of the anionic modified vegetable gums used in the invention is at least 0.01 and preferably at least 0.1.

If the degree of substitution is less than 0.01, the efficacy of the implementation of the elimination of the natural or synthetic organic matter from the liquid to be treated is reduced.

If the degree of substitution exceeds 0.1, just as in the case of the cationic modified vegetable gums, the vegetable gum inevitably swells in the liquid, and, in the same manner as in the case of the cationic modified vegetable gums, in order to be able to use a modified vegetable gum substituted to a degree of greater than 0.1, it is preferable to subject it to a modification to make it insoluble. These modifications are described later.

The degree of substitution of the anionic modified vegetable gum corresponds to the mean number of anionic charges per sugar unit.

Among the modifications of the vegetable gum intended to improve its affinity for the natural or synthetic organic substances, mention may be also be made of the introduction of uncharged hydrophilic or hydrophobic groups.

Among the hydrophilic groups that may be introduced, mention may be made especially of one or more saccharide or oligosaccharide residues, one or more ethoxy groups, one or more hydroxyethyl groups, and an oligoethyleneoxide.

Among the hydrophobic groups that may be introduced, mention may be made especially of an alkyl, aryl, phenyl, benzyl, acetyl, hydroxybutyl or hydroxypropyl group, or a mixture thereof.

The term “alkyl or aryl or acetyl radical” means alkyl or aryl or acetyl radicals containing from 1 to 22 carbon atoms.

The degree of substitution of the vegetable gums modified with uncharged hydrophilic or hydrophobic groups used in the invention is at least 0.01 and preferably at least 0.1.

The degree of substitution of the vegetable gum modified with uncharged hydrophilic or hydrophobic groups corresponds to the mean number of uncharged hydrophilic or hydrophobic groups per sugar unit.

It is possible to perform several of the modifications proposed above for increasing the affinity of the vegetable gum with respect to natural or synthetic organic substances on the same vegetable gum.

Among the modifications of the vegetable gum intended to make it insoluble, mention may be made especially of the possibility of performing chemical crosslinking of the vegetable gum, or else by chemically or physically adsorbing it onto a water-insoluble mineral or organic support.

Preferably, chemical crosslinking of the vegetable gum is used to make it insoluble.

Chemical crosslinking of the vegetable gum may be obtained via the action of a crosslinking agent chosen from formaldehyde, glyoxal, halohydrins such as epichlorohydrin or epibromohydrin, phosphorus oxychloride, polyphosphates, diisocyanates, bis(ethyleneurea), polyacids such as adipic acid or citric acid, acrolein, and the like.

The chemical crosslinking of the vegetable gum may also be obtained via the action of a metallic complexing agent, for instance zirconium(IV) or sodium tetraborate.

The chemical crosslinking of the vegetable gum may also be obtained under the effect of an ionizing radiation.

The degree of insolubilization of the vegetable gum is satisfactory when the mass fraction of soluble organics in the vegetable gum is less than 10%.

As indicated previously, the modifications intended to improve the affinity of the vegetable gum for the natural or synthetic organic substances, and the modifications intended to make it insoluble, may be performed separately and in the order desired.

It may also be possible to perform these modifications simultaneously.

As examples in which the modifications of the vegetable gum are performed simultaneously, mention may be made of an insoluble cationic vegetable gum obtained by placing the vegetable gum in contact with excess epichlorohydrin and a trimethlyamine. The epichlorohydrin generates in situ a reagent bearing a quaternary ammonium, which will make it possible to render the vegetable gum cationic, on the one hand. The excess epichlorohydrin makes it possible, on the other hand, to crosslink the vegetable gum.

The optionally modified and optionally insoluble vegetable gum of the invention may be used in the form of a powder or alternatively may be formed into granules.

The chemical crosslinking reaction may be exploited to obtain insoluble granules of vegetable gum.

In an industrial installation, these granulated products have the advantage of being able to be used in a column, in the same manner as exchange resins, thus offering a large area for exchange while limiting the pressure drop.

It is possible to use the optionally modified and optionally insoluble vegetable gum of the invention alone or as a mixture with other agents for trapping natural or synthetic organic substances, for instance exchange resins, active charcoal or cationic celluloses.

Among the possible combinations, the preferred combination is that of an optionally modified and optionally insoluble vegetable gum of the invention with active charcoal.

The mass fraction of vegetable gum in the mixture may be between 5-95% and, reciprocally, the mass fraction of active charcoal may be between 95-5%.

Preferably, the mass fraction of vegetable gum in the mixture may be between 40-60% and, reciprocally, the mass fraction of active charcoal may be between 60-40%.

It is also possible to mix the optionally modified and optionally insoluble vegetable gum of the invention with inert fillers such as polymer powder or sand to ballast it.

The elimination of the natural or synthetic organic substances present in the liquid is performed by introducing the optionally modified and optionally insoluble vegetable gum of the invention into the liquid to be treated, with stirring for the necessary duration, which is between a few minutes and a few hours, followed by removing from the treated liquid the vegetable gum onto which the natural or synthetic organic substances have been adsorbed, by means of an operation such as separation by centrifugation, filtration including membrane filtration, sedimentation or the like.

In addition, a sequential treatment with active charcoal may be used, for example.

The natural organic matter present in water results mainly from the total or partial decomposition of plants, animals and microorganisms. It is naturally present in natural waters, but its amounts and characteristics are different depending on the sources of water under consideration (lakes, rivers, underground waters, stream, ocean), their geographical location and the season.

It is, however, possible to give mean values of concentrations of natural organic matter encountered in waters intended for the production of drinking water: for a surface water, the concentration ranges from 2 to 10 mg/l for the total organic carbon (TOC); whereas for an underground water, the mean value of the total organic carbon (TOC) is between 0.5 and 1.0 mg/l.

The nature of the natural organic matter varies from one water course to another. This finding implies that the chemical characterization of the natural organic matter may be difficult to generalize.

In general, it is considered that natural organic matter is divided into two separate categories: the hydrophobic matter (humic and fulvic acids) and the hydrophilic matter (proteins, carbohydrates, amino acids and peptides).

Humic acids are the compounds which, in natural organic matter, have the highest molecular weight. This is mainly due to the high concentration of aromatic carbon relative to the concentration of carboxylic acids and carbonyls.

Fulvic acids are of lower molecular weight than humic acids. Their aromatic carbon concentration is lower than that of humic acids.

However, the concentrations of carbonyl and of carboxylic acids in fulvic acids are higher than those in humic acids. Fulvic acids represent the major fraction of natural organic matter (i.e. close to 50%) compared with the fraction of humic acids, which is about 5%.

The natural organic matter present in water may also comprise algal toxins. These are organic molecules synthesized by bacteria. Among these algal toxins, mention may be made of dermatotoxins, neurotoxins and hepatotoxins. Among the hepatotoxins, mention may be made of microcystins and in particular microcystin-LR. These algal toxins may cause organoleptic problems, but they may especially result in health problems. This is especially the case for hepatotoxins and in particular for microcystin-LR.

The natural organic matter present in beverages, fruit juices and syrups is well known to those skilled in the art.

Mention may be made, for example, in the case of sweetened beverages, of sugar colorants, which are macromolecules in the form of hydrophobic carbon-based chains with a hydrophilic end at their weak acid function.

The organic matter present in industrial effluents depends on the industrial processes in which the water has been used.

Among the organic matter present in industrial effluents, mention may be made especially of “manufacturing” dyes or natural dyes. Reference may be made to the document entitled “couplage de décoloration et de la nanofiltration des éluats de régénération en raffinerie de canne [coupling of decolorization and nanofiltration of regeneration eluates in sugar cane refinery]” AVH association, 6th Symposium, Reims, March 1999.

The synthetic organic matter present in water results mainly from agricultural or industrial pollution as regards pesticides, including insecticides, herbicides or fungicides; domestic effluents as regards detergents, including surfactants; from the petroleum and transportation industry as regards hydrocarbons, including crude oil and derivatives thereof; from various industries as regards organochlorine compounds such as PCBs, insecticides, chlorinated solvents, and in waste-water from pharmaceutical products such as antibiotics or endocrine disruptors.

The list of synthetic organic matter is very long, and reference may be made especially to the appendix to Decision No. 2455/2001/EC of the European Parliament and of the Council of 20 Nov. 2001, which establishes a list of the priority substances in the water sector, published in the Official Journal of the European Community of 15.12.01 L/331/1 to 5.

Among the synthetic organic substances that may especially be mentioned are: alachlor, anthracene, atrazine, benzene, brominated diphenyl ethers, C₁₀₋₁₃-chloroalkanes, chlorfenvinphos, chlorpyrifos, 1,2-dichloroethane, dichloromethane, di(2-ethylhexyl) phthalate (DEHP), diuron, endosulfan, alpha-endosulfan, fluoranthene, hexachlorobenzene, hexachlorobutadiene, hexachlorocyclohexane, the gamma isomer of lindane, isoproturon, napththalene, nonylphenols, 4-(para)nonylphenol, octylphenols, para-tert-octylphenol, pentachlorobenzene, pentachlorophenol, polycyclic aromatic hydrocarbons, benzo (a) pyrene, benzo(b)fluoranthene, benzo(g.h.i)perylene, benzo(k)fluoranthene, indeno-(1,2,3-cd)pyrene, simazine, trichlorobenzene, 1,2,4-trichlorobenzene, trichloromethane (chloroform) or trifluralin.

The cationic modified vegetable gum or the cationic modified vegetable gum made insoluble is used when the liquid to be treated contains natural or synthetic organic substances that have anionic or anionizable substituent groups, for example phenols, phenoxides, carboxylic acids, carboxylates, phosphates, sulfates or hydrogen sulfides.

The anionic modified vegetable gum or the anionic modified vegetable gum made insoluble is used when the liquid to be treated contains natural or synthetic organic substances that have cationic or cationizable groups, for example amines or ammonium groups.

The vegetable gum modified with uncharged hydrophilic groups or the vegetable gum modified with uncharged hydrophilic groups and made insoluble is used when the liquid to be treated contains natural or synthetic organic substances that have hydrophilic groups, for example saccharide or oligosaccharide residues.

The vegetable gum modified with uncharged hydrophobic groups or the vegetable gum modified with uncharged hydrophobic groups and made insoluble is used when the liquid to be treated contains natural or synthetic organic substances that have hydrophobic groups, for example alkyl, phenyl, benzyl, acetyl, hydroxybutyl or hydroxypropyl groups.

In addition, two or more of the abovementioned types of vegetable gum and/or of modified vegetable gum may be used, in the form of a mixture of two or more types, or alternatively they may be used together.

The amount of modified vegetable gum that is added may be selected in an appropriate manner as a function of the concentration of natural or synthetic organic substances in the liquid to be treated and of the exchange capacity of the modified vegetable gum.

The modified vegetable gum of the invention can be used for fixing organic compounds present in urines.

The examples that follow are given as nonlimiting illustrations.

### EXAMPLES

### A—Examples of Preparation of the Vegetable Gums of the Invention

### Example A-1 (Guar A): Synthesis of an Insolubilized Cationic Guar—DS=0.2

15 g of Jaguar C 17 (cationic guar powder of DS=0.2 sold by Rhodia HPCII) and 120 ml of isopropyl alcohol (2-propanol) are placed in a jacketed cylindrical 500 ml reactor equipped with a mechanical stirrer of anchor type, a dropping funnel and a condenser. The reaction medium is stirred for 3 minutes at 100 rpm under a nitrogen atmosphere. 5.5 ml of 50% sodium hydroxide solution are then added, followed, after 3 minutes, by addition of 22.5 ml of demineralized water and 3.5 ml of epibromohydrin. The mixture is maintained at 60° C. for 1 hour and then cooled. After cooling to room temperature, 600 ml of demineralized water are added to the reactor, which is stirred for 2 hours, then the stirring is stopped and the mixture is left to stand for 2 hours to allow the solid to settle out. The supernatant is removed by suction using a filter-tipped cannula, and 600 ml of demineralized water are then reintroduced into the reactor. The reaction medium is returned to pH 6 by adding 1 N hydrochloric acid. It is then stirred for 2 hours. The solid+liqud mixture is then filtered through a No. 3 sinter funnel. The filter cake is taken up in ½ liter of demineralized water heated to 70° C. with vigorous stirring for 2 hours, after which time the stirring is stopped and the mixture is left to settle. The supernatant is removed by suction using a filter-tipped cannula. The operation of washing by redispersion in ½ liter of demineralized water, settling and removal of the supernatant is repeated 4 times with cold water. After the final wash, the solid that settles out is separated out and then frozen and dried by freeze-drying. 13 g of very aerated white powder that impregnates easily into water but does not dissolve are obtained.

### Example A-2 (Guar B): Synthesis of an Insolubilized Cationic Guar—DS=0.34

5 g of demineralized water, 60 g of Quab 151 (solution of epoxypropyltrimethylammonium chloride at 70% in water, sold by Degussa AG) and 280 ml of isopropyl alcohol (2-propanol) at 70% in demineralized water are introduced into a jacketed cylindrical 1 liter reactor equipped with a mechanical stirrer of anchor type, a dropping funnel and a condenser. The assembly is placed under a nitrogen atmosphere and stirred at 100 rpm. 100 g of Meyro-Guar CSA 200/50 HF guar powder sold by Rhodia Food are introduced into the reactor. The reactor is heated to 45° C. (jacket temperature) by circulation of hot water. Once the temperature has been reached, it is maintained for 30 minutes with stirring. 20 g of sodium hydroxide as a 23.5% solution in demineralized water are then added dropwise over 20 minutes. Once the addition is complete, the reactor is brought to 60° C. and maintained at this temperature for 60 minutes. After cooling to room temperature, the reaction medium is filtered through a No. 3 sinter funnel. The filtercake is returned to the reactor. A further 280 ml of isopropyl alcohol (2-propanol) at 70% in demineralized water are added and the stirring is restarted at 100 rpm. 5 g of demineralized water and 60 g of Quab 151 are added, and the reactor is brought to 45° C. (jacket temperature). Once the temperature is reached, it is maintained for 30 minutes with stirring. 170 ml of isopropyl alcohol are then added. Once the addition is complete, the reactor is brought to 60° C. and maintained at this temperature for 45 minutes. After cooling to room temperature, 8 ml of 99% acetic acid are added and the mixture is stirred for 20 minutes. The reaction medium is filtered through a No. 3 sinter funnel. The filtercake is washed with 340 ml of isopropyl alcohol and then filtered again. The cake is dried in a vacuum oven at 500C for 16 hours. After drying, 128.2 g of a pale yellow powder are obtained. The elemental analysis on nitrogen shows that this product has a cationic DS of 0.34.

This cationic guar with a high degree of substitution is then insolubilized by chemical crosslinking with epibromohydrin, according to the protocol described in Example 1.

### Example A-3 (Guar C): Synthesis of an Insolubilized Cationic Hydroxypropyl Guar

The protocol described in Example A-2 is repeated, starting with Jaguar 8000, hydroxypropyl guar of MS hydroxypropyl=0.4 sold by Rhodia HPCII.

After the cationization step, a cationic HP-guar with a cationic DS=0.45 is obtained, which is insolubilized according to the protocol described in the preceding examples.

### Example A-4 (Guar D): Synthesis of a Cationic Guar of DS=0.2, Rendered Hydrophobic by Benzylation and Insolubilized

80 ml of isopropyl alcohol are introduced into a 250 ml three-necked flask equipped with a mechanical stirrer of anchor type, a condenser, a dropping funnel and heated by an oil bath. The assembly is flushed with nitrogen U. Stirring is started at 100 rpm. 20 g of Jaguar C-17 (cationic guar powder of DS=0.2, sold by Rhodia HPCII) are introduced. The mixture is stirred for 30 minutes at room temperature, and 1.13 g of sodium hydroxide dissolved in 20 ml of demineralized water are then added. The mixture is stirred for a further 90 minutes at room temperature, 4.93 g of benzyl bromide are then added and the reaction medium is brought to 60° C. Stirring is continued for 4 hours from the point at which the temperature of 60° C. is reached. After this stage, the mixture is cooled by immersing the flask in a water+ice mixture. It is filtered through a No. 3 sinter funnel to isolate the solid, which is washed with 600 ml of 80/20 isopropyl alcohol/demineralized water mixture. The washing operation is repeated twice and the filtercake is then dried at 45° C. under a vacuum partially compensated with nitrogen.

The quantification of the DS benzyl obtained is performed by proton NMR. For this analysis, an acid hydrolysis step is necessary in order to obtain good solubility of the sample in the solvent used (deuterated DMSO). This pretreatment consists in dissolving 100 mg of polymer in 20 ml of 2 M trifluoroacetic acid and maintaining the mixture at 95° C. for 4 hours under a flow of nitrogen. At the end of the hydrolysis, the water and the acid are devolatilized under vacuum and an aliquot of the solid residue is taken up in the analysis solvent (deuterated DMSO). After integration of the various signals and calculation, it is concluded that the DS benzyl obtained is 0.21.

The benzylated cationic guar is then insolubilized according to the protocol given in Example A-1.

### Example A-5 (Guars E1 to E6): Synthesis of Cationic Hydroxypropyl Guars Insolubilized with Different Degrees of Chemical Crosslinking

The cationic hydroxypropyl guar of MS hydroxypropyl=0.32 and of cationic DS=0.45 prepared in Example A-3 is insolubilized according to the protocol described in Example A-1, by homothetically varying the amounts of sodium hydroxide and epibromohydrin used. The following series of samples is thus prepared:

TABLE I

| | Mass of epibromohydrin used |
|---|---|
| Reference | relative to the mass of polymer |
| Guar E1 | 5% |
| Guar E2 | 10% |
| Guar E3 | 20% |
| Guar E4 | 30% |
| Guar E5 | 40% |
| Guar E6 | 50% |

### B—Examples of Evaluation of the Vegetable Gums of the Invention

This test is performed on a natural water from the Rennes region, which has been subjected beforehand to a coagulation/flocculation treatment. 1 mg of modified guar is placed in a 150 ml Pyrex beaker with 100 ml of water to be treated, with stirring. This experiment is performed at 7° C. After a contact time of 30 minutes, the residual concentration of natural organic matter in solution is assayed. The assay of the natural organic matter is performed either by UV spectrophotometry at 254 nm with a Shimadzu UV-160 model 204-04550 machine, or by assaying the total organic carbon using a Shimadzu TOC-5000A analyzer. These measurements are performed after filtering the samples using filters with a Millex syringe in PVDF and of porosity 0.45 μm, prerinsed with ultrapure water.

Moreover, the performance of the modified guars was compared with that of Picactif PCO 15-35 active charcoal powder from the company PICA. The results are given in Table II.

TABLE II

| | | | | Percentage of |
|---|---|---|---|---|
| | Total organic | Percentage of | UV | elimination |
| | carbon (TOC) | elimination | absorbance at | of the UV |
| | mg/l | of the TOC | 254 nm | absorbance |
| Natural water from Rennes | 2.48 ± 0.10 | | 0.193 ± 0.002 | |
| after coagulation/flocculation | | | | |
| Picactif PCO 15-35 active | 2.10 ± 0.10 | 15% | 0.173 ± 0.002 | 10% |
| charcoal powder | | | | |
| Guar A | 2.35 ± 0.10 | 5% | 0.176 ± 0.002 | 9% |
| Guar B | 2.30 ± 0.10 | 7% | 0.175 ± 0.002 | 9% |
| Guar C | 2.20 ± 0.10 | 11% | 0.185 ± 0.002 | 4% |
| Guar D | 2.18 ± 0.10 | 12% | 0.171 ± 0.002 | 12% |
| Guar E1 | 2.18 ± 0.10 | 12% | 0.178 ± 0.002 | 8% |
| Guar E2 | 2.29 ± 0.10 | 8% | 0.181 ± 0.002 | 6% |
| Guar E3 | 2.29 ± 0.10 | 8% | 0.178 ± 0.002 | 8% |
| Guar E4 | 2.24 ± 0.10 | 10% | 0.177 ± 0.002 | 8% |
| Guar E5 | 2.36 ± 0.10 | 5% | 0.178 ± 0.002 | 8% |
| Guar E6 | 2.30 ± 0.10 | 7% | 0.174 ± 0.002 | 10% |

These tests demonstrate the efficacy of the modified guars for eliminating natural organic matter. Moreover, it is noted that they give a performance similar to that of active charcoal powder and that the variation of the structural parameters (degree of cationic substitution: comparison guars A and B, degree of crosslinking: comparison guars E1 to E6) has little impact on the performance.

On the other hand, the introduction of benzyl units appears to have a favorable impact on the performance (comparison of guars A and D).

1.-27. (canceled)

28. A process for removing unwanted natural or synthetic organic impurities from a liquid medium contaminated therewith, comprising introducing into said liquid medium a thus effective amount of an optionally modified/insoluble cationic vegetable gum containing one or more cationic or cationizable substituents, maintaining the cationic vegetable gum in said liquid medium until said organic impurities are sorbed thereon, and thence recovering said vegetable gum/sorbed impurities therefrom, whereby purifying said liquid medium.

29. The process as defined by claim 28, wherein the vegetable gum is selected from the group consisting of glucomannans, konjac, xyloglucans, tamarind gum, galactomannans, guar, carob, tara, fenugreek, mesquite gum, gum arabic, or mixtures thereof.

30. The process as defined by claim 29, wherein the vegetable gum is selected from among the galactomannans.

31. The process as defined by claim 28, wherein said cationic or cationizable substituents are selected from the group consisting of quaternary ammoniums or tertiary amines, pyridiniums, guanidiniums, phosphoniums and sulfoniums.

32. The process as defined by claim 28, wherein said cationic or cationizable substituents are introduced into said vegetable gum via nucleophilic substitution reaction.

33. The process as defined by claim 28, wherein said cationic or cationizable substituents are introduced into said vegetable gum via esterification with amino acids, glycine, lysine, arginine or 6-aminocaproic acid, or with quaternized amino acid compounds, betaine hydrochloride.

34. The process as defined by claim 28, wherein said cationic or cationizable substituents are introduced into said vegetable gum via free-radical polymerization comprising the grafting of monomers including at least one cationic or cationizable substituent onto the gum.

35. The process as defined by claim 34, wherein said monomers are selected from among the compounds of formulae (i), (II), (III) and (IV) below:
the compound of general formula (I): 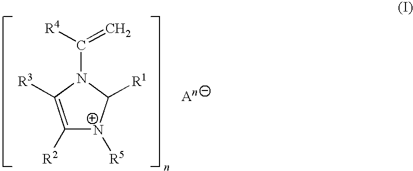
in which:
A^{nΘ} is a Cl^{Θ}, Br^{Θ}, I^{Θ}, SO₄^{2Θ}, CO₃^{2Θ}, CH₃—OSO₃^{Θ}, OH^{Θ} or CH₃—CH₂—OSO₃^{Θ} ion,
R¹ to R⁵, which may be identical or different, are each, independently, an alkyl radical having from 1 to 20 carbon atoms, a benzyl radical or an H atom, and
n is 1 or 2, or
the compound of general formula (II): 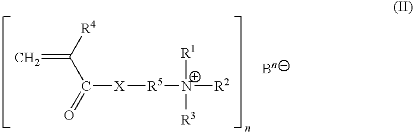
in which:
X is an —NH group or an oxygen atom O,
R⁴ is a hydrogen atom or an alkyl radical having from 1 to 20 carbon atoms,
R⁵ is an alkylene radical having from 1 to 20 carbon atoms,
R¹, R² and R³, which may be identical or different, are each, independently, an alkyl radical having from 1 to 20 carbon atoms,
B^{NΘ} is a Cl^{Θ}, Br^{Θ}, I^{Θ}, SO₄^{2Θ}, CO₃^{2Θ}, CH₃—OSO₃^{Θ}, OH^{Θ} or CH₃—CH₂—OSO₃^{Θ} ion, and
n is 1 or 2, or
the compound of general formula (III): 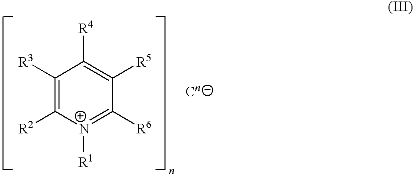
in which:
R¹ to R⁶, which may be identical or different, are each, independently, a hydrogen atom or an alkyl radical having from 1 to 20 carbon atoms, with the proviso that one of the groups R¹ to R⁶ is a —CH═CH₂ radical,
C^{NΘ} is a Cl^{Θ}, Br^{Θ}, I^{Θ}, SO₄^{2Θ}, CO₃^{2Θ}, CH₃—OSO₃^{Θ}, OH^{Θ} or CH₃—CH₂—OSO₃^{Θ} ion, and
n is 1 or2, and
the compound of general formula (IV): 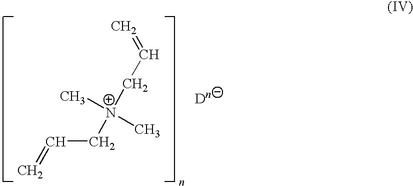
in which:
D^{nΘ} is a Cl^{Θ}, Br^{Θ}, I^{Θ}, SO₄^{2Θ}, CO₃^{2Θ}, CH₃—OSO₃^{Θ}, OH^{Θ} or CH₃—CH₂—OSO₃^{Θ} ion, and
n is 1 or 2.

36. The process as defined by claim 34, wherein said monomers are selected from the group consisting of:
2-dimethylaminoethyl acrylate (DAEA),
quaternized 2-dimethylaminoethyl acrylate (DAEA-Quat),
2-dimethylaminoethyl methacrylate (DMAEMA),
quaternized 2-dimethylaminoethyl methacrylate (DMAEMA-Quat),
2-diethylaminoethyl methacrylate quaternized in chloride form,
diallyldimethylammonium chloride (DADMAC),
trimethylammoniumpropylmethacrylamide in chloride form (MAPTAC), and
mixtures thereof.

37. The process as defined by claim 28, said vegetable gum containing negatively charged counterion substituents selected from the group consisting of chloride, bromide, iodide, fluoride, sulfate, methyl sulfate, phosphate, hydrogen phosphate, phosphonate, carbonate, hydrogen carbonate and hydroxide ions.

38. The process as defined by claim 28, wherein the degree of substitution of the vegetable gum modified by one or more cationic substituents is at least 0.01.

39. The process as defined by claim 28, wherein an insoluble vegetable gum is provided by chemical crosslinking of the vegetable gum, or by chemically or physically adsorbing same onto a water-insoluble mineral or organic support.

40. The process as defined by claim 39, wherein the insoluble vegetable gum is provided by chemical crosslinking.

41. The process as defined by claim 40, wherein the chemical crosslinking of the vegetable gum is obtained via the reaction of a crosslinking agent selected from the group consisting of formaldehyde, glyoxal, halohydrins, epichlorohydrin, epibromohydrin, phosphorus oxychloride, a polyphosphate, a diisocyanate, bis(ethyleneurea), a polyacid, adipic acid, citric acid and acrolein.

42. The process as defined by claim 40, wherein the chemical crosslinking of the vegetable gum is obtained via the reaction of a metallic complexing agent, zirconium(IV) or sodium tetraborate.

43. The process as defined by claim 40, wherein the chemical crosslinking of the vegetable gum is obtained via the effect of an ionizing radiation.

44. The process as defined by claim 40, wherein the crosslinking is performed until the mass fraction of soluble organics in the vegetable gum is less than 10%.

45. The process as defined by claim 28, wherein a cationic modified and insoluble vegetable gum is provided in the form of a powder or is formed into granules.

46. The process as defined by claim 28, wherein a cationic modified and insoluble vegetable gum is mixed with another agent for sorbing natural or synthetic organic contaminants.

47. The process as defined by claim 28, wherein a modified and insoluble vegetable gum is mixed with an inert filler.

48. The process as defined by claim 28, said organic impurities comprising algal toxins, and/or hydrophobic species, humic and fulvic acid, and/or hydrophilic species, proteins, carbohydrates, amino acids or peptides.

49. The process as defined by claim 28, said organic impurities comprising synthetic pesticides, insecticides, herbicides or fungicides; detergents, surfactants; hydrocarbons, crude oil and derivatives thereof; organochlorine compounds, PCBs, insecticides, chlorinated solvents, or pharmaceutical products comprising antibiotics or endocrine disruptors.

50. The process as defined by claim 28, wherein a cationic modified vegetable gum or an insoluble cationic modified vegetable gum is employed when the liquid to be treated contains natural or synthetic organic contaminants that have anionic or anionizable substituents.

51. The process as defined by claim 28, wherein the vegetable gum is a mixture of two or more types thereof and/or of modified vegetable gums.

52. The process as defined by claim 28, said liquid medium being drinking water, a beverage, a fruit juice or a syrup.

53. The process as defined by claim 28, said liquid medium being a natural water, an industrial water or a wastewater.

54. The process as defined by claim 28, said liquid medium being a urine.

55. The process as defined by claim 28, said cationic vegetable gum containing one or more hydrophilic and/or hydrophobic substituents.
